(19) United States
(12) Patent Application Publication
(10) Pub. No.: US 2022/0150228 A1
(43) Pub. Date: May 12, 2022

(54) COMPUTER SYSTEMS AND METHODS INCLUDING HTML BROWSER AUTHORISATION APPROACHES

(71) Applicant: BankVault Pty Ltd, West Perth (AU)

(72) Inventors: Graeme SPEAK, West Perth (AU); Neil RICHARDSON, Cannington (AU)

(21) Appl. No.: 17/442,694

(22) PCT Filed: Mar. 30, 2020
(86) PCT No.: PCT/AU2020/050314

§ 371 Date: Sep. 24, 2021

(30) Foreign Application Priority Data
Mar. 28, 2019 (AU) 2019901053

(51) Int. Cl. H04L 9/40

(52) U.S. Cl. CPC H04L 63/0435; H04L 63/18; H04L 63/083; H04L 63/061

(57) ABSTRACT

In one form of the present invention, there is provided a computer implemented method 10 of enabling one or more access provider systems 12 to secure access to content on first electronic devices 14, the computer implemented method 10 comprising: receiving encrypted input information 16, the encrypted input information 16 being inputted by users 18 on second electronic devices 20; and transmitting input information 16 to the one or more access provider systems 12 to allow the one or more access provider systems 12 to determine whether to authorise access to content on the first electronic devices 14.

### INCORPORATION BY REFERENCE

All parts and elements of earlier filed PCT Application PCT/AU2018/050349 dated 18 Apr. 2018 and entitled ‘VIRTUAL MACHINES—COMPUTER IMPLEMENTED SECURITY METHODS AND SYSTEMS’ are hereby fully incorporated by reference.

### FIELD OF THE INVENTION

The present invention relates to computer system and methods. In one particularly preferred form there is provided an HTML browser based authentication approach.

### BACKGROUND TO THE INVENTION

There are various problems associated with the secure provision of content from access provider systems to users or secure provision of content from a user to a secured system.

Various systems are known that claim to provide security for access provider systems. These security systems commonly suffer from problems associated with key loggers, screen scraping, man-in-the-middle, man-in-the-browser attacks and other approaches that are able to circumvent the secure provision of content.

In addition to attack surface problems, security systems are also known to suffer from hardware and software problems associated with speed, resource and software architecture integration.

Problems associated with systems providing two factor authentication are also known. These systems typically suffer from anonymity and access code intrusion problems. SMS system services are considered to be particularly weak in security aspects due to the nature of the transmission protocols that are often employed. One-Time-Passcode systems such as a FOB can be breached by a man-in-the-browser either intercepting or altering data entered into the browser.

It would be advantageous if an improved or useful alternate security systems and methods could be provided to those commonly used in the security industry.

It is against this background and the problems and difficulties associated therewith that the inventor(s) has developed the present invention.

### SUMMARY OF THE INVENTION

According to a first aspect herein described there is provided a computer implemented method of enabling an access provider system to secure access to content on a first electronic device, the computer implemented method comprising: receiving encrypted input information, the encrypted input information being inputted by a user on a second electronic device; and transmitting input information to the access provider system to allow the access provider system to determine whether to authorise access to the first electronic device.

The first aspect can be applied to authorise access to multiple devices, accordingly in a second aspect herein described there is provided a computer implemented method of enabling one or more access provider systems to secure access to content on first electronic devices, the computer implemented method comprising: receiving encrypted input information, the encrypted input information being inputted by users on second electronic devices; and transmitting input information to the one or more access provider systems to allow the one or more access provider systems to determine whether to authorise access to the first electronic devices.

Preferably the method includes providing a system service having an application interface, the application interface for receiving the encrypted input information and transmitting the received encrypted input information from the system service to the one or more access provider systems. In an embodiment, (i) each access provider system has access to decryption keys for decrypting the transmitted input information; and (ii) the system service does not have access to the decryption keys and is unable to decrypt the received encrypted input information.

Preferably the method includes generating session identifiers; each session identifier for identifying a user input session in association with a corresponding access provider system and a corresponding second electronic device.

Preferably the method includes each access provider system generating a secret key for each session identifier associated with the access provider system.

Preferably the method includes presenting each session identifier and the corresponding secret key as a visual representation on the first electronic devices for scanning by the second electronic devices.

Preferably the method includes using each secret key in the encryption of information that is inputted by the user for the purposes of obtaining access to content on the corresponding first device.

Preferably the method includes collating encrypted input information inputted by the users using the second electronic devices, based on the corresponding session identifiers; and providing collated input information associated with each session identifier to the one or more access provider systems based on the corresponding session identifiers.

Preferably the or each session identifier comprises an identifier of the respective access provider system and the method further comprises storing the respective access provider system identifier in the respective second device.

Preferably the method also comprises storing the respective access provider system identifier and one or both of a device identifier or a non-predicable number as a remembered identifier in the respective second device.

Preferably the method also includes transmitting the remembered identifier to the access provider system.

Preferably the respective access provider system compares the received remembered identifier to a previously received remembered identifier having the same second device identifier.

Preferably the method includes receiving requests from the one or more access provider systems to provide input session identifiers, each input session identifier being provided for use in providing secure access to content from an associated access provider system to a user.

In an embodiment the method includes providing a software application on each of the second electronic devices, the software application for providing an input system for use in authorizing a user to access content on a first electronic device. In an alternative embodiment, each second electronic device comprises a virtual input device. Preferably the virtual input device is displayed for receipt of input.

Preferably the method includes transmitting content-agnostic and length-aware input information to corresponding first electronic devices after receiving input information from the second electronic devices.

Alternatively the method includes transmitting content-agnostic and length-unaware input information to corresponding first electronic devices after receiving input information from the second electronic devices.

Preferably the method includes receiving display element selection information from the first devices as further input information from the users that is made directly on the first devices.

Preferably the method includes monitoring display element changes on each first user device made directly by the corresponding user.

Optionally the method includes informing corresponding second electronic devices of display element selection on the first electronic devices.

According to an aspect described herein there is provided a computer implemented method of enabling an access provider system to secure access to content on an electronic device via a first communication channel between the access provider system and the electronic device, the computer implemented method comprising: receiving encrypted input information via a second communication channel between a second device and the access provider system, the encrypted input information being inputted by a user; and transmitting input information to the access provider system to allow the access provider system to determine whether to authorise access to the first electronic device.

Preferably the information is inputted by the user on the second device.

Preferably the method further comprises implementing the or each second device in the form of an input device on the, or each corresponding, first device.

Preferably the inputted information is unable to be provided to the access provider system via the first communication channel.

According to an aspect herein described there is provided a computer implemented method of enabling an access provider system associated with a corresponding session identifier to secure access to content on a first electronic device, the computer implemented method comprising: receiving, via an application interface provided by a system service, encrypted input information that is inputted by a user on a second electronic device along with the session identifier identifying an input session; the second user device providing an encrypted communication channel independent of the first electronic device; and transmitting, via the application interface, input information inputted by the user using the second electronic device to the access provider system; wherein the system service is agnostic of the decryption key required to decrypt the encrypted input information.

According to an aspect herein described there is provided a computer implemented method of enabling a plurality of access provider systems to secure access to content on first electronic devices, the computer implemented method comprising: receiving, via an application interface provided by a system service, encrypted input information that is inputted by users on second electronic devices along with session identifiers each identifying an input session; the second user devices providing encrypted communication channels independent of the first electronic devices; and transmitting, via the application interface, input information inputted by the users using the second electronic devices to the access provider systems associated with corresponding session identifiers; wherein the system service is agnostic of the decryption keys required to decrypt the encrypted input information.

Preferably the method includes providing a session identifier and a secret key from each first device to a respective second device. Preferably the method includes providing the session identifier along with the secret key in a visual representation on each of the first electronic devices, the visual representation for being scanned using the respective second electronic device; using each secret key in the encryption of information that is inputted by the user using the corresponding second electronic device; and transmitting the encrypted information from each second electronic device along with the session identifier to the application interface.

Preferably the method includes collating encrypted input information received via the application interface; and providing the collated encrypted input information to the one or more access provider systems based on the corresponding session identifiers. Alternatively, the collation may be performed by the access provider system.

Preferably the method includes storing an access providing system identifier in the respective second device during a first session and transmitting the stored access provider system identifier to the respective access provider system in a subsequent session via the application interface.

According to an aspect herein disclosed there is provided a computer implemented method of enabling an access provider system associated with a corresponding session identifier to secure access to content on a first electronic device via a first communication channel, the computer implemented method comprising: receiving, via second communication channel with an application interface provided by a system service, encrypted input information that is inputted by a user along with the session identifier identifying an input session; the second communication channel being encrypted and independent of the first commination channel; and transmitting to the access provider system, via the application interface, the encrypted input information inputted by the user; wherein the system service is agnostic of the decryption key required to decrypt the encrypted input information.

According to an aspect herein described there is provided a computer implemented system for enabling an access provider system to secure access to content on a first electronic device, the computer implemented system comprising: a receiver for receiving encrypted input information that is inputted by a user on a second electronic device; and a transmitter for providing input information to the access provider system to allow the access provider system to determine whether to authorise access to the content on the first electronic device.

According to an aspect herein described there is provided a computer implemented system for enabling one or more access provider systems to secure access to content on first electronic devices, the computer implemented system comprising: a receiver for receiving encrypted input information that is inputted by users on second electronic devices; and a transmitter for providing input information to the one or more access provider systems to allow the one or more access provider systems to determine whether to authorise access to the content on the first electronic devices.

Preferably the system includes a service providing an application interface, the application interface for receiving the encrypted input information and transmitting the received encrypted input information from the system service to the one or more access provider systems, in addition (i) each access provider system has access to decryption keys for decrypting the transmitted input information; and (ii) the system service does not have access to the decryption keys and is unable to decrypt the received encrypted input information.

Preferably the system includes a generator for generating session identifiers; each session identifier for identifying a user input session in association with a corresponding access provider system and a corresponding second electronic device.

Preferably each access provider system includes a secret key generator for generating a secret key for each session identifier associated with the access provider system.

Preferably each access provider system includes a generator for generating a session identifier and the corresponding secret key as a visual representation on the first electronic devices for scanning by the second electronic devices.

Preferably the system includes an encryptor using each secret key in the encryption of information that is inputted by the user for the purpose of obtaining access to content on the corresponding first device.

Preferably the system includes a collator for collating encrypted input information inputted by the users using the second electronic devices, based on the corresponding session identifiers; the transmitter for providing collated input information associated with the session identifiers to the one or more access provider systems based on the corresponding session identifiers.

Preferably the system includes a session identifier request receiver for receiving requests from the one or more access provider systems to create input session identifiers, each input session identifier for use in providing secure access to content from an associated access provider system to a user.

Preferably the system includes an input receiver on each of the second electronic devices, the input receiver comprising an application for use in authorizing a user to access content on a first electronic device.

Preferably the system includes an advisor for transmitting content-agnostic and length-aware input information to corresponding first electronic devices after the receiver receives input information from the second electronic devices.

Alternatively the system includes an advisor for transmitting content-agnostic and length-unaware input information to corresponding first electronic devices after the receiver receives input information from the second electronic devices.

Preferably the system includes a display selection receiver for receiving display element selection information from the first devices as further input information from the users in connection with the monitoring of display elements on each first user device.

Preferably the system includes a monitor for monitoring the display elements on each first user device.

Preferably the system includes an informer for informing corresponding second electronic devices of display element selection on the first electronic devices.

According to an aspect herein described there is provided a computer implemented method of providing secure access to content from an access provider system to a user, the computer method comprising: maintaining a web application for providing the user with access to content via a html browser installed on a first user device, the first user device for accessing content from the access provider system; decrypting input information that is inputted by the user on the second user device; and authorizing access to secured content based on the decrypted input information.

According to an aspect herein described there is provided a computer implemented method of providing secure access to content from one or more access provider systems to users, the computer method comprising: maintaining a web application for providing users with access to content via html browsers installed on first user devices, the first user devices for accessing content from a variety of access provider systems; decrypting input information that is inputted by the users on second user devices; and authorizing access to secured content based on the decrypted input information.

Preferably the content comprises hypertext markup content.

Preferably the method includes maintaining session identifiers and a secret key that is associated with each session identifier; providing one or more display elements and updating the one or more display elements with content-agnostic input information, as a result of input information being entered on second electronic devices each associated with a corresponding one of the session identifiers.

Preferably the method includes monitoring the display elements and transmitting display element selection information for use in updating the second electronic devices.

Preferably the method includes receiving the encrypted inputted information from an intermediary system between the second user device and the access provider system.

Preferably the method includes maintaining an access provider system identifier and providing the access provider system identifier to the first devices for storage thereon. Further the method includes receiving a first identifier from the second user devices in one session and comparing a second identifier received from the second user devices in a subsequent session and for sessions between each first device and the same access provider system pair comparing the received first identifier to the second identifier.

According to an aspect herein described there is provided a computer implemented method of providing secure access to content from an access provider system to a user, the computer method comprising: maintaining a web application for providing the user with access to content via a html browser installed on a user device, the user device for accessing content from the access provider system via a first communication channel; decrypting input information that is inputted by the user and received via a second communication channel independent from the first communication channel; and authorizing access to secured content based on the decrypted input information.

According to an aspect herein described there is provided a computer implemented system of providing secure access to content from an access provider systems to users, the computer system comprising: a web application for providing a user with access to content via a html browser installed on a first user device, the first user device for accessing content from the access provider system; and an authorizer having a decryptor for decrypting input information inputted by the user on the second user device, the authorizer for using the decrypted input information to determine whether to authorise access to content.

According to an aspect herein described there is provided a computer implemented system of providing secure access to content from one or more access provider systems to users, the computer system comprising: a web application for providing users with access to content via html browsers installed on first user devices, the first user devices for accessing content from a variety of access provider systems; and an authorizer having a decryptor for decrypting input information inputted by the users on second user devices, the authorizer for using the decrypted input information to determine whether to authorise access to content.

Preferably the content comprises hypertext markup content.

Preferably the system includes a maintainer for maintaining session identifiers and a secret key that is associated with each session identifier; a provider for providing one or more display elements; and an updater for updating the one or more display elements with content-agnostic input information, as a result of input information being entered on second electronic devices each associated each with a corresponding one of the session identifiers.

Preferably the system includes a monitor for monitoring the display elements and transmitting display element selection information for use in updating the second electronic devices.

According to an aspect herein described there is provided a computer implemented method of securing access to content stored by an access provider system, the method comprising: providing a web system service for the access provider system that enables the access provider system to authorize secure user access to content on a first electronic device associated with a user; providing the user with an application for communicating with the web system service using a second electronic device associated with the user; receiving encrypted input information inputted by the user on the second user device; and forwarding the received encrypted input information to the access provider system, wherein the access provider system has the ability to decrypt the encrypted input information for determining whether to authorise access to the user to content on the first user device.

According to an aspect herein described there is provided a computer implemented method of securing access to content stored by one or more access provider systems, the method comprising: providing a web system service for the one or more access provider systems that enables the access provider systems to authorize secure user access to content on first electronic devices, each first electronic device being associated with a user; providing each user with an application for communicating with the web system service using second electronic devices, each being associated with a user; receiving encrypted input information inputted by the users on second user devices; and forwarding the received encrypted input information to the one or more access provider systems with the one or more access provider systems having the ability to decrypt the encrypted input information for determining whether to authorise access to the users to content on the first user devices.

According to an aspect herein described there is provided a computer implemented system of securing access to content stored by an access provider system, the system comprising: a web system service for the access provider system that enables the access provider system to authorize secure user access to content on a first electronic device associated with a user; an input system for communicating with the web system service using a second electronic device associated with the user; a receiver for receiving encrypted input information inputted by the user on the second user device; and a forwarder for forwarding the received encrypted input information to the access provider system wherein the access provider system has the ability to decrypt the encrypted input information for determining whether to authorise access to the user to content on the first user device.

According to an aspect herein described there is provided a computer implemented system of securing access to content stored by one or more access provider systems, the system comprising: a web system service for the one or more access provider systems that enables the access provider systems to authorize secure user access to content on first electronic devices, each first electronic device being associated with a user; an input system for communicating with the web system service using second electronic devices, each being associated with a user; a receiver for receiving encrypted input information inputted by the users on second user devices; and a forwarder for forwarding the received encrypted input information to the one or more access provider systems with the one or more access provider systems having the ability to decrypt the encrypted input information for determining whether to authorise access to the users to content on the first user devices.

According to an aspect herein described there is provided a method comprising: receiving a request from a first device to access a service, the request being received at an access provider system via a first communication channel; responding to the first device via the first communication channel with a webpage including a session identifier, an encryption key, an identifier of the access provider system providing the response and a call to provide a virtual input device for receiving input from a user either via the virtual input device being implemented on a second device or via the virtual input device being implemented on the first device; receiving input information entered using the virtual input device which is encrypted using the encryption key and which is send to the access provider system via a second communication channel different from the first communication channel and where a decryption key for decrypting the encrypted input information is only known to the access provider system; associating the received encrypted input information with a session linked to the session identifier of the access provider system having the access provider system identifier; decrypting the encrypted input information at the access provider system using the decryption key; verifying that the decrypted input information is as expected and when that is the case providing access to the service.

According to an aspect herein described there is provided a method comprising: receiving a request from a device for providing a virtual input device with a session identifier, an encryption key, and an identifier of an access provider system; implementing the virtual input device in a manner in which the virtual input device encrypts input by a user of the device using the provided encryption key and which the input by the user is not accessible in a non-encrypted form from outside of the virtual input device, other than by the access provider system identified by the identifier of the access provider system, which has a decryption key; sending the encrypted input with the session identifier to the access provider system as identified by the identifier of the access provider system.

In an embodiment of the above aspects, part of the input information is provided via the second device and part is provided via a third device. Preferably each of the second and third devices implement a virtual input device where the inputs are combined. Preferably the combination is according to the timing of input by respective users. Alternatively the combination is according to an identity of the respective users of the respective second and third devices.

According to an aspect herein described there is provided a computer program product comprising instructions stored in a tangible form which when executed by a processor cause a computing system to perform any one or more of the methods herein described, or to configure a computer system or device to be configured as herein described.

From the perspective of an access provider system, one advantage is that several preferred embodiments are addressed toward the problem of man-in-the-browser and/or key logger attacks on the first electronic devices.

Another advantage of aspects is that the integration work required for an access provider system is limited. Each access provider system is able to readily integrate with a system service API. The system service itself is content-agnostic of the user information inputted using the second electronic devices. Furthermore, in several preferred embodiments, there is no need to substantially modify the access provider system's current web system service architecture or modify the password authentication system.

In the case of access provider systems, the providers are provided (in several embodiments) with a second communication path that is isolated from their web architecture. The second communication path preferably allows the provider to authenticate a user using the second communication path and then account access is provided through the user's local browser on the user's local machine.

The access provider systems are provided with the ability to communicate with an API and decrypt collated inputs that are inputted by the user on the second devices. The access provider is able to communicate directly with the users providing their own secret for data encryption of an input session. The system service providing the API is content-agnostic in the sense of being unable to decrypt the input information inputted by the users.

From the context of the users, each user is able to login using a second authentication path that bypasses their local machine for authorization, while after authorization still being able to use their own web browser. For this reason, users can readily employ their own customizations in the form of installed browser extensions or otherwise.

The users are able to use a single input means on the second electronic devices. Using the input application the users are able to access different access provider systems that use the security of several embodiments. The system service is input content-agnostic and the browser is isolated from access input entry. A clientless infrastructure is provided by the user's local machine. Furthermore users are provided with a seamless experience by virtue of preferred form synchronisation approaches with the browser display elements being updated in a content-agnostic manner. Users are able to see keypress events on their browser without having to be provided with virtual machine software.

From the context of the system service provider employing various embodiments, a collator is able to readily collate input information from users and forward the input information to access provider systems in a content-agnostic manner. The system service provider is unaware of the content of the input made using the second device and does not necessarily have to allocate a virtual machine before authenticating a user and providing browser access to the content. The system service provider does not store any relevant user information at all in various embodiments for the reason that the information is encrypted using keys with decryption known only to the access provider systems.

It is to be recognised that other forms and advantages of preferred embodiments will be apparent from the drawings and description of preferred embodiments, and the claims provided below.

Further advantages and preferred features will be apparent from the drawings and a reading of the specification as a whole.

### BRIEF DESCRIPTION OF DRAWINGS

In order to facilitate a better understanding of the present invention, several preferred embodiments will now be described with reference to the accompanying drawings.

### DETAILED DESCRIPTION OF THE EMBODIMENTS

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

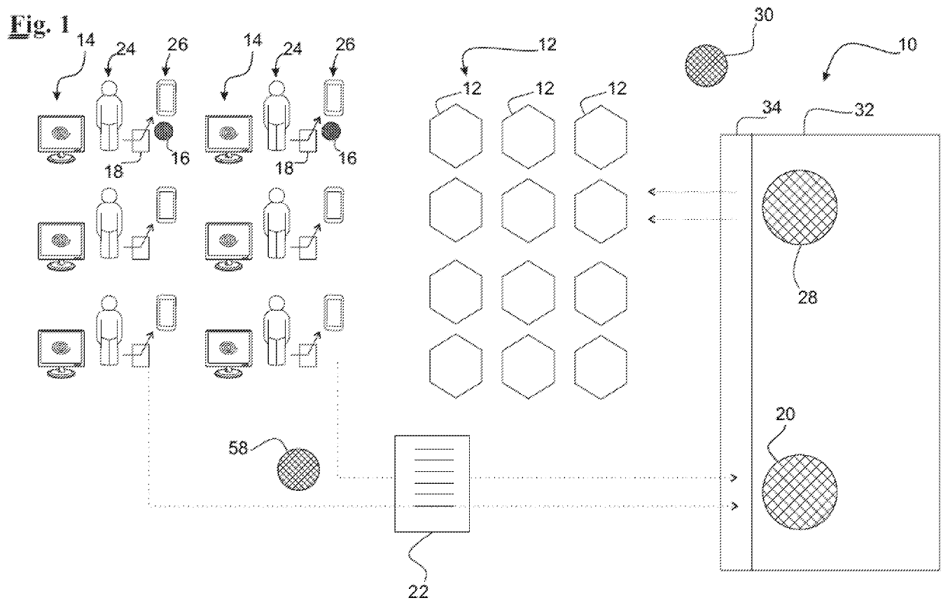

Referring to FIG. 1 there is shown a computer implemented method 10 of enabling one or more access provider systems 12 to secure access to content on first electronic devices 14. Advantageously the access provider systems 12 may comprise financial institution systems for providing customers with secure access to their financial account information or for otherwise securely dealing with their financial accounts (such as for instance the transfer of funds). Preferred systems are considered to be particularly suitable for banks and other financial service providers.

At step 16 the method 10 includes input information 18 being entered by a number of users 24 into a number of second electronic devices 26. The second devices 26 receive and encrypt the entered input information 18. The input information 18 is sent from each second electronic device 26 in encrypted form.

At step 20 the method 10 includes receiving encrypted input information 22 that was inputted by users 24 as input information 18 of the second electronic devices 26. In the embodiment each second electronic device 26 comprises the corresponding users' mobile phone 26 having an installed application that provides encryption and camera visual code scanning functions. Various visual code scanning functions could be employed in various embodiments including two dimensional barcode scanning, such as Quick Response (QR) code scanning. QR code scanning is employed by the present embodiment.

At step 28 the method 10 includes transmitting encrypted input information 22 to the one or more access provider systems 12 to allow the one or more access provider systems 12 to determine whether to authorise access to content on the first electronic devices 14. In this embodiment the input information 22 comprises encrypted keypress information 22. The encrypted keypress information 22 is sent to the application providers 12.

At step 30, the method 10 advantageously includes providing a system service 32 having an application interface 34. The application interface 34 is provided for receiving the encrypted input information 22 and transmitting the received encrypted input information 22 from the system service 32 to the access provider systems 12.

In this embodiment the application interface 34 comprises a REST based application programming interface. Different forms of interface (such as by using Simple Object Access Protocol (SOAP), GraphQL or Remote Procedure Calls (RPC)) may be utilized in other embodiments.

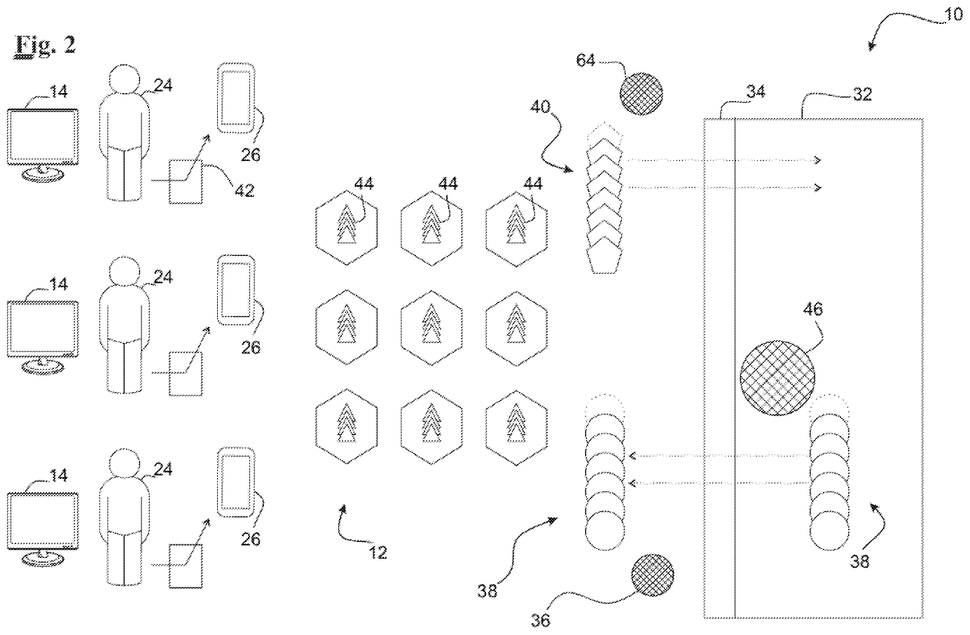

Referring to FIG. 2, at step 36 the method 10 includes the access provider systems 12 being provided with session identifiers 38. The access provider systems 12 issue requests 40 for the session identifiers 38. A corresponding session identifier 38 is generated by the system service 32 in response to each request 40.

In the method 10 the access provider systems 12 use the session identifiers 38 for identifying input sessions 42 each associated with a corresponding user 24 inputting information into their corresponding second device 26 to obtain access to content to be provided on the corresponding first electronic devices 14. As will be described in further detail below, the encrypted keypresses (forming part of the encrypted input information 22) are collated by the system service 32.

In the method 10 each access provider system 12 has access to decryption keys 44 for decrypting the transmitted input information 22. In this embodiment a hash based encryption and decryption approach is employed with the decryption making use of hash tables. In this embodiment a secret key 44 is generated by each access system provider for each session identifier 38. Each secret key 44 provides both an encryption and decryption key (using hash tables) that is associated with a session identifier 38.

The system service 32 is decryption-agnostic by not having access to the decryption keys 44. The system service 32 is advantageously unable to decrypt the received encrypted input information 22 for this reason.

At step 46 the method 10 includes generating the session identifiers 38. Each session identifier 38 is provided for identifying a corresponding user input session 42 in association with a corresponding access provider system 12 and a corresponding second electronic device 26. In this embodiment, each session identifier 38 is associated with a single user input session in relation to a corresponding first device 14. Preferably sessions identifiers 38 are not reused on termination of an input session 42. Various approaches are of course possible in different embodiments.

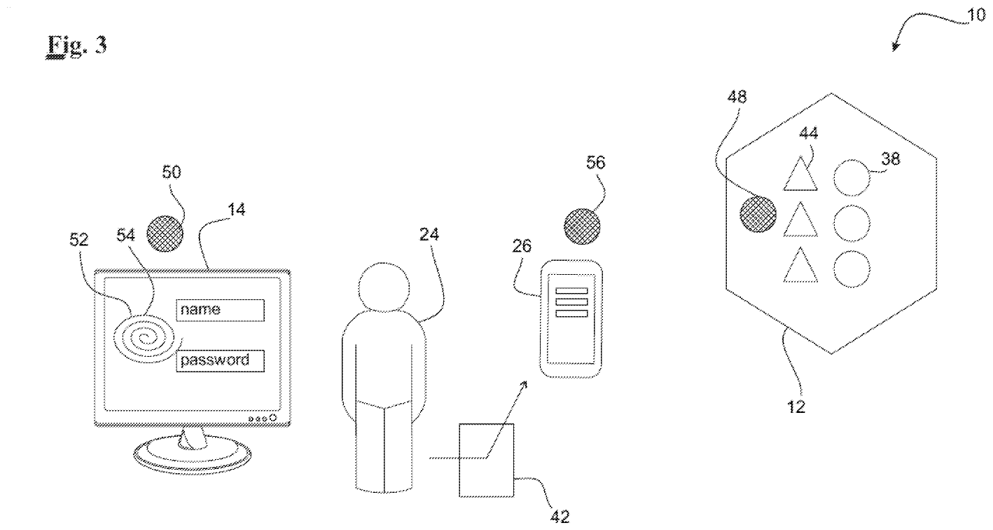

Referring to FIG. 3, at block 48 the method 10 includes each access provider system 12 generating a secret key 44 for each session identifier 38 associated with the access provider system 12.

At step 50 the method 10 includes presenting each session identifier 38 and the corresponding secret key 44 as a visual representation 52 on the first electronic devices 14 for scanning by the second electronic devices 26. In this embodiment the session identifiers 38 are identifiers that are unique to the system service 32. The visual representation 52 preferably comprises a QR Code 54 that includes a unique session identifier 38 and the corresponding secret (encryption) key 44. The QR Code 54 also includes information for automatically opening an input application on the second device 26. Methods of automatically opening applications on user devices using QR Codes are known.

At step 56 an embodiment of the method 10 includes scanning of each visual representation 52 using a corresponding second device 26. The method 10 further includes using each secret key 44 scanned by the corresponding second device 26 in the encryption of information 22 that is inputted by the user in an input session 42. Each input session 42 provides an authorisation mechanism for the user to enter a name and password (or another form of identifier) for user authorisation via a second channel remote from the corresponding first device 14. The input session 42 allows the user 24 the opportunity of obtaining access to content on the corresponding first device 14.

By providing the respective session identifier 38, such as by scanning the visual representations 52, each second device 26 becomes associated with the corresponding first device 14 displaying the visual representation 52. In this embodiment the user does not have to be logged into the scanning related input application. The scanned session identifier 38 associates the user 24 with the corresponding first device 14, the corresponding second device 26 and the associated account provider system 12.

Returning to FIG. 1, at step 58 the method 10 includes transmitting the encrypted information 22 from each second electronic device 26 along with the session identifier 38 to the application interface 34. This occurs after the first device 14 has been provided with the session identifier 38 and the secret key 44 and the second device 26 has scanned the session identifier 38 and the secret key 44. Only the access provider system 12 and the second device 26 knows the secret key 44 that corresponds with the session identifier 38. Advantageously for this reason, only the access provider system 12 can decrypt the input information inputted using the corresponding second device 26. Thus the system service 32 is content-agnostic.

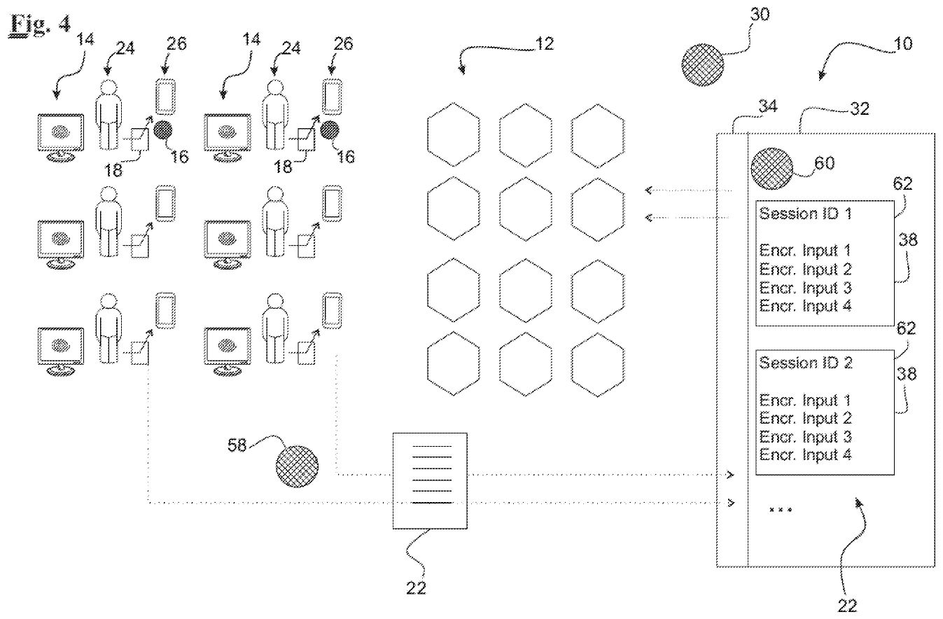

Referring to FIG. 4, at step 60 the method 10 includes collating encrypted input information 22 inputted by the users 24 using the second electronic devices 26. The collation is based on the corresponding session identifiers 38. Providing the collated input information 62 to the one or more access provider systems 12 is based on the corresponding session identifiers 38. In this embodiment, each session identifier 38 in use at any one time and is unique among the session identifiers 38.

Returning to FIG. 2, in this embodiment, at step 64 the method 10 includes receiving requests 40 from the one or more access provider systems 12 to generate input session identifiers 38, each input session identifier 38 for use in providing secure access to content from an associated access provider system 12 to a user 24 via a corresponding first device 14.

Having described the above, it is to be appreciated that various approaches are possible in computing systems to achieve the same result. In this embodiment the system service 32 generates the unique session identifiers 38. In other embodiments an application provider 12 may generate a session identifier that is unique to the application provider which may be combined with a unique access provider system identifier (unique to the system service 32) to generate a unique session identifier. Such generation approaches could be performed by the access provider systems 12 and not the system service 32. Other variations are possible.

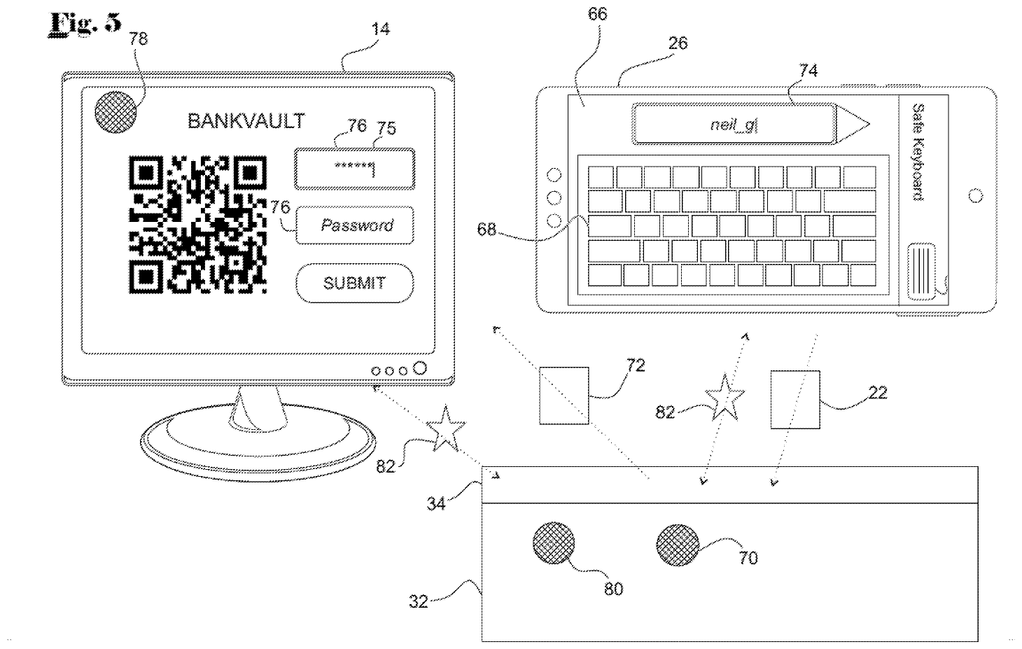

Referring to FIG. 5, the method 10 includes providing a software application 66 on each of the second electronic devices 26. In this embodiment the software applications 66 provide a virtual keyboard 68 having standard entry keys a to z, 0 to 9, special characters including !”£$%\hat{ }& and a shift key. Other input systems could of course be provided such as different alphabets/characters. The software applications 66 provide the keyboard for use in authorizing a user to access content on a first electronic device 14. In this embodiment each software application 66 provides a virtual keyboard through a virtual machine connection to an external machine. In an embodiment the virtual keyboard 68 registers each key touch and sends the key (character) touched as the input information 22. In a preferred embodiment the virtual keyboard 68 registers each position of the touch of a microcell (area) under the displayed key in the input information 22 and the system service 32 converts the position of the microcell touched into a key entered. In a further alternative the access system 12 does the conversion to the key touched. With the latter two cases the virtual keyboard can be morphed between instances, such as by changing the position of each microcell of each virtual key (for example, by shuffling between alphabetic order keyboard, QWERTY, AZERTY and DVORAK keyboard) thereby preventing the same key being in the same position every time.

At step 70 the method 10 advantageously includes transmitting input content-agnostic and length-aware information 72 to corresponding first electronic devices 14 after receiving input information 22 from the second electronic devices 26. In this embodiment, when a second electronic device 26 is used by a user to input access information 22, the system service 32 sends the first electronic device 14 associated with the session identifier 38 the content-agnostic and length-aware information 72. The information 72 comprises an indicator 72 of the total character length that has been entered into the associated second device 26 for being shown by the first device 14 in a selected display element 75. The entered information is shown on the second device 26 in field 74. In embodiments employing HTML display elements 76 to display information, symbols having no association with the content such as a number of asterisks are displayed to indicate the character length. Should a backspace have been entered, this would be a negative character length change, should a first character be present for a field selection. In the present embodiment both display element 76 updates to the first device 14 are shown using asterisks. The position is shown using a vertical line (pipe). Thus the user is able to enter his or her password into the second device 26 with only symbols (content agnostic information) being known to the first device 14. In other embodiments no field information may be shown on the first device 14 at display element 75. This is presently not preferred as confirmation of keypresses and display field changes provides an advantageous approach.

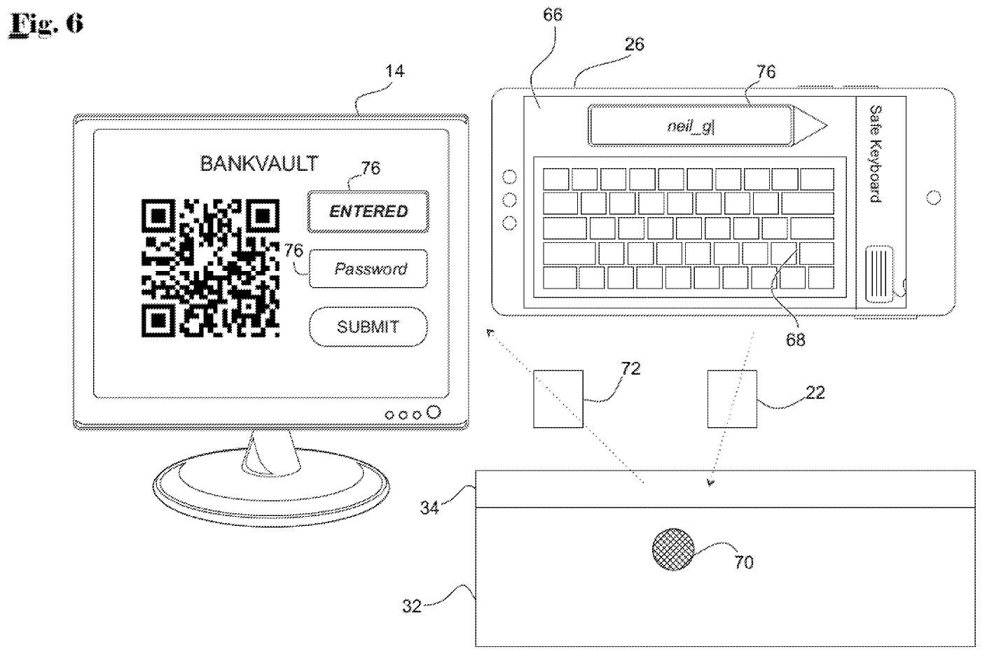

In yet another embodiment shown in FIG. 6, the transmitted input information may be length-agnostic in that only an indicator of completed input information for a field is transmitted to the associated first device 14 from the system service 32. For example, a user may enter their email address neil_g@bv.net.au and a display element may show “ENTERED” or another similar/standard expression. In this manner the first electronic devices 40 are updated with content-agnostic information 56.

Returning to FIG. 5, the method 10 at step 78 includes monitoring display elements 76 on each first user device 14 for selection changes made directly (by using the keyboard or mouse of the first device 14) by the corresponding user 24. The method 10 at step 80 further includes receiving display element selection information 82 from each first device 14 as further input information from the respective users 24. In input sessions, users are able to select display fields 76 directly on the respective first input devices 14 and have that selection reflected on the corresponding second electronic device 26.

The method 10 includes informing each of the corresponding second electronic devices 26 of the selection of the display elements 76 by users 24 directly on the respective first electronic devices 14. The display element selection information 82 is recorded by the system service 32 as an input in connection with the corresponding session identifier 38. The corresponding second device 26 is advised of the input via the system service 32. Other methods of advising the second device 26 are possible.

The method 10 can be applied to circumstances involving a plurality of access provider systems 12. In such circumstances there is provided a method 10 of enabling a plurality of access provider systems 12 to secure access to content on first electronic devices 14.

From one viewpoint, the method 10 includes receiving, via an application interface 34, encrypted input information 22 that is inputted by users 24 on second electronic devices 26 along with session identifiers 38 each identifying an input session 42, the second user devices 26 providing an encrypted communication channel independent of the first electronic devices 14; and transmitting, via the application interface 34, input information 22 inputted by the users 24 using the second electronic devices 26 to the access provider systems 12 associated with corresponding session identifiers 38; and ensuring that the system service 32 is agnostic of the decryption keys required to decrypt the encrypted input information 22.

The method 10 includes providing a session identifier 38 along with a secret key 44 in a visual representation 52 on each of the first electronic devices 14. The visual representation is provided for being scanned using a second electronic device 26. Each secret key 44 is used in the encryption of information 22 that is inputted by the user using the corresponding second electronic device 26. The method 10 includes transmitting the encrypted information 22 from each second electronic device 26 along with the session identifier 38 to the application interface 34. The method 10 includes collating encrypted input information 22 received via the application interface 34 and providing the collated encrypted input information 22 to the one or more access provider systems 12 based on the corresponding session identifiers 38.

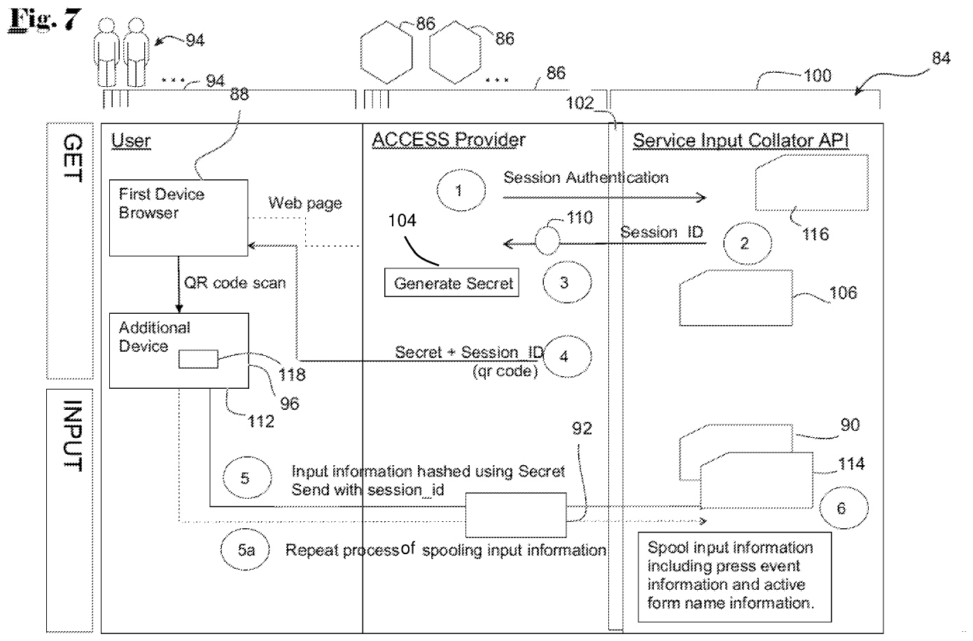

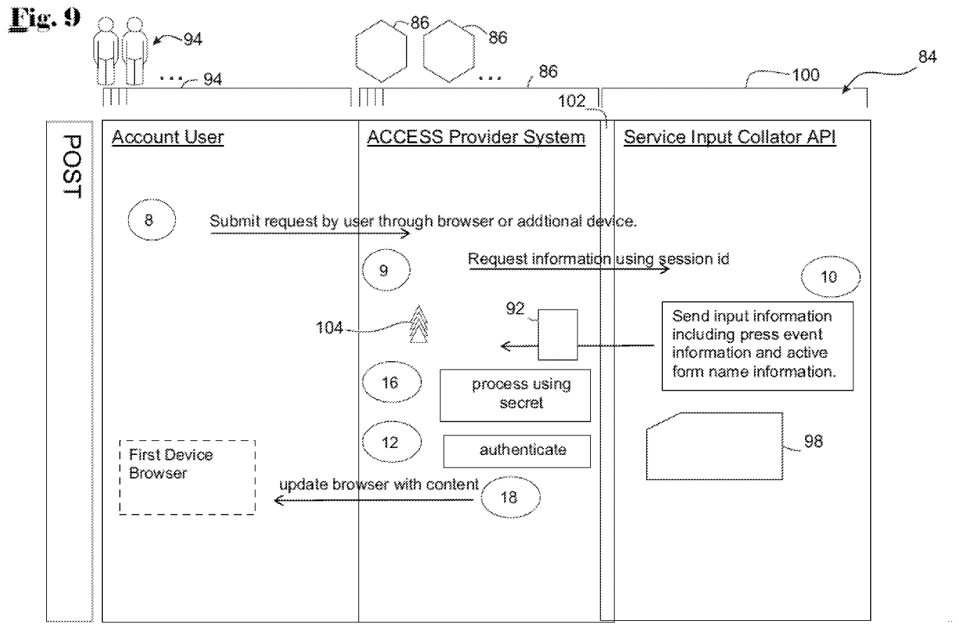

In another embodiment shown in FIGS. 7 to 9, there is provided a computer implemented system 84 for enabling one or more access provider systems 86 to secure access to content on first electronic devices 88. The computer implemented system 84 comprises: a receiver 90 for receiving encrypted input information 92 that is inputted by users 94 on second electronic devices 96. Referring to FIG. 9, the system 84 further includes a transmitter 98 for providing input information 92 to the one or more access provider systems 86 to allow the one or more access provider systems 86 to determine whether to authorise access to content on the first electronic devices 88.

The system 10 includes a service 100 providing an application interface 102 for receiving the encrypted inputted information 92 and transmitting the received encrypted input information 92 from the system service 100 to each access provider system 86. Additionally (i) each access provider system 86 has access to decryption keys 104 for decrypting the transmitted input information 92. Advantageously the system service 100 does not have access to the decryption keys 104 and is unable to decrypt the received encrypted input information 92.

The computer system 84 includes a generator 106 for generating session identifiers 110. Each session identifier 110 is provided for identifying a user input session 112 in association with a corresponding access provider system 86 and a corresponding second electronic device 96.

The computer system 10 includes a collator 114 for collating encrypted input information 22 inputted by the users 94 using the second electronic devices 96 based on the corresponding session identifiers 110. The transmitter 98 (FIG. 9) is provided for transmitting collated input information 92 associated with the session identifiers 110 to the one or more access provider systems 86 based on the corresponding session identifiers 110.

The computer system 84 includes a session identifier request receiver 116 for receiving requests from the one or more access provider systems 86 to provide input session identifiers 110. Each session identifier 110 is provided for use in providing secure access to content from an associated access provider system to a user 94.

The computer system 10 includes an input receiver 118 on each of the second electronic devices 96. The input receiver comprises an application 118 for use in authorizing a user 94 to access content on a corresponding first electronic device 88.

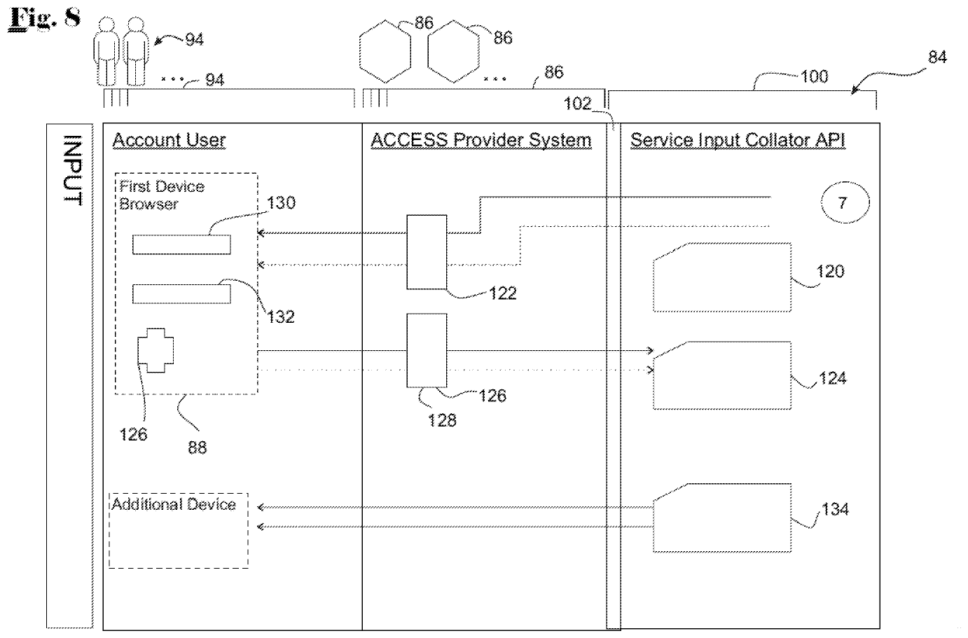

The computer system 84 includes an advisor 120 (FIG. 8) for transmitting input content-agnostic information 122 to corresponding first electronic devices 88 after the receiver 90 receives input information 92 from the second electronic devices 96.

The computer system 10 includes a display selection receiver 124 for receiving display element selection information 126 from the first devices 88 as further input information 128 from the users 94 in connection the input session.

The computer system 10 includes a monitor 132 for monitoring the display elements 130 on each first user device 88.

The computer system 10 includes an informer 134 for informing corresponding second electronic devices 96 of direct user display element 130 selection on the first electronic devices 96.

The systems and methods described above provide embodiments of the present invention. Each component could be considered a system operating in the context of its own method. In the embodiments described the access provider systems provide content that is processed and displayed on html browsers on the first electronic user's devices. The systems and methods of the access provider systems could be considered a further embodiment of the present invention.

The access provider systems provide secure access to content to the users. In an access provider method according to one embodiment there is provided at a first step maintaining a web application for providing users with access to content via html browsers installed on first user devices. The first user devices are able to access content from a variety of access provider systems.

At a second step the method includes decrypting input information that is inputted by the users on second user devices; and authorizing access to secured content based on the decrypted input information.

In the embodiment the content comprises hypertext markup content that is served by the web applications of the access provider systems.

At a third step the method includes maintaining session identifiers and a secret key that is associated with each session identifier. One or more display elements are provided and the method includes updating the one or more display elements with content-agnostic input information, as a result of input information being entered on second electronic devices each associated with a corresponding one of the session identifiers.

An access provider system embodiment is provided as a web application for providing users with access to content via html browsers installed on first user devices. The web application includes an authorizer having a decryptor for decrypting input information inputted by the users on second user devices, the authorizer for using the decrypted input information to determine whether to authorise access to content. A maintainer is provided for maintaining session identifiers and a secret key that is associated with each session identifier. The system includes a provider for providing one or more display elements. An updater is provided for updating the one or more display elements with content-agnostic input information, as a result of input information being entered on second electronic devices each associated with a corresponding session identifier.

In a further embodiment there is provided a computer implemented method of securing access to content stored by one or more access provider systems. At a first step the method includes providing a web system service for the one or more access provider systems that enables the access provider systems to authorize secure user access to content on first electronic devices, each first electronic device being associated with a user. At a second step the method includes providing each user with an application for communicating with the web system service using second electronic devices, each being associated with a user. At a third step the method includes receiving encrypted input information inputted by the users on second user devices. At a fourth step the method includes forwarding the received encrypted input information to the one or more access provider systems with the one or more access provider systems having the ability to decrypt the encrypted input information for determining whether to authorise access to the users to content on the first user devices.

In a related embodiment there is provided a web system service for the one or more access provider systems that enables the access provider systems to authorize secure user access to content on first electronic devices with each first electronic device being associated with a user. An input system is provided for communicating with the web system service using second electronic devices, each being associated with a user. A receiver is provided for receiving encrypted input information inputted by the users on second user devices. A forwarder is provided for forwarding the received encrypted input information to the one or more access provider systems with the one or more access provider systems having the ability to decrypt the encrypted input information for determining whether to authorise access to the users to content on the first user devices.

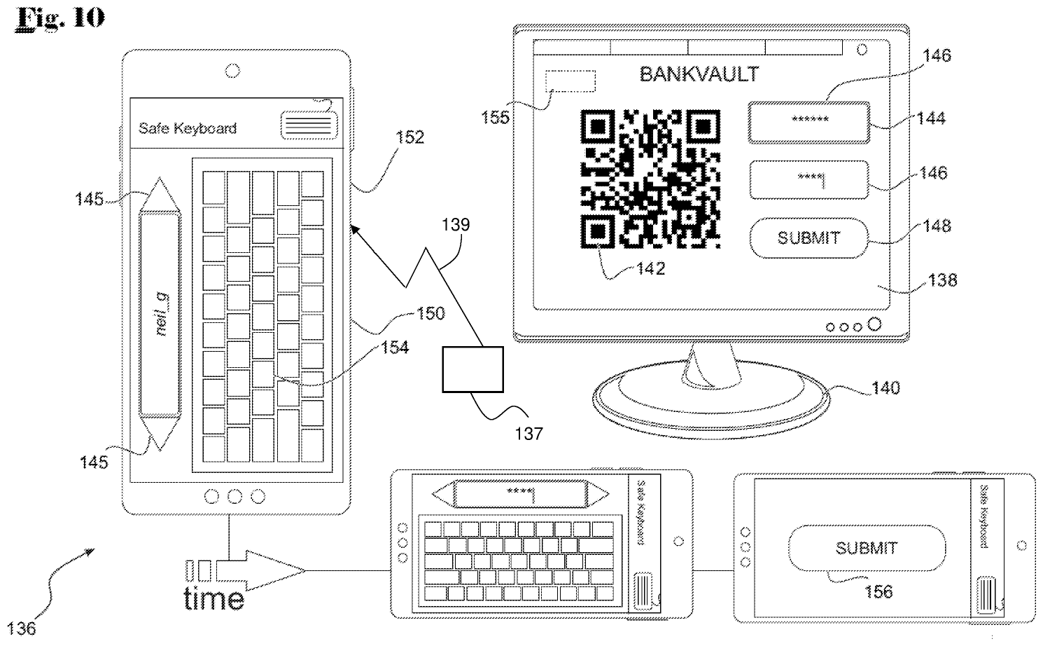

Referring to FIG. 10, in a method 136 according to a further embodiment of the present invention a user wishes to access an account provided by an account provider 137. The user uses his or her own web browser 138 with installed extensions on the user's local machine 140. The user visits the website of her or her account provider and activates a login button on the account providers website. After activating the login button the user is presented with a QR code 142 along with a name field display element 144 and password field display element 146 and a submit element 148.

The account provider 137 generates the QR code 142 and incorporates a unique session identifier and a secret key for an input session on a second device 150 into a message 139 sent to the local machine 140. The QR code 142 is scanned using the second user device 150 with the secret key being captured from the first device along with the session identifier. Both the account provider 137 and the second device 150 know the secret key. The first device 140 does not know the secret key in the sense of using the secret key, although it is encoded in the QR code.

On the second device 150, a conventional QR code scanner is able to read the QR code 142, extract and then send the session id and secret key to a system application 152 installed on the second device 150. In other embodiments the system application 152 contains the QR code scanner.

The system application 152 provides an input receiver 154 for receiving user inputs. In this embodiment a keyboard 154 is provided (such as a digital keyboard displayed on a touchscreen) for inputting digits, numbers and special characters. Advantageously a user is able to select a display element 144 for the user name on the first device. A monitor 155 (which in this embodiment is written in JavaScript or another language) is connected to a system service from the web browser of the first device 140 and sends the display element selection and session identifier to the system service. The display element selection on the first device 140 is considered a user input. The user is also able to select a display element on the second device using selectors 147. The selection on the second device 150 is considered a user input and is transmitted along with a session identifier to the system service. In this manner there is provided advantageous selection of input elements. Advantageously the web browser is entirely content-agnostic for the purpose of authorisation to content.

In an embodiment, the monitor 155 knows which form element 146 is active, and is informed by the system service when a key has been pressed on the mobile app 152. The monitor 155 also advantageously knows the session id for communicating with the system service.

The monitor 155 is provided as JavaScript for easy integration with the application provider's system and communication with the system service. The monitor 155 communicates with the system service via a websocket. Other TCP/IP communication approaches are of course possible. As would be known, the ‘WebSocket’ protocol is a computer communications protocol, providing full-duplex communication channels over a single TCP connection. The WebSocket protocol was standardized by the IETF as RFC 6455 in 2011. Other communications protocols that could be used include the Hypertext Transfer Protocol with a Restful or non-Restful API. TCP/IP protocols are of course preferred, however other protocols could also be used.

In this embodiment the monitor 155 provides a websocket for communicating display field changes to the system service. More particularly, in this embodiment, websockets are used to provide communication between (i) the first device and the system service; (ii) and the second device and the system service. With the first device, a browser such as Chrome provides support websockets. With the second device, a websocket library can be used for the mobile application 152. With the system service websocket server libraries are available for web servers. The channels of communication could of course be provided by other protocols.

In this embodiment a fall-back mechanism is provided using standard web transfer protocols using standard request handlers. In the fall-back mechanism when active element is changed in the form, the web browser sends send a POST request to the API server with the name of the new active element.

In this embodiment, the system service maintains a store of inputs made by the user on the second device along with the session identifier that is sent with the inputs made on the second device to the system service. The system service informs the web browser of inputs in a content-agnostic but length aware manner.

The user is able to initiate a submit request on the first device by pressing submit element 148. A submission request is also able to be sent to the system service by pressing submit element 156 on the second device 150. After a submit request the encrypted inputs are collated and pushed from or pulled to the account provider in association with the session identifier. Advantageously the system service does not know the secret keys associated with the session identifiers. The account provider, and the second device 150 know the session identifier and secret key associated with the second device. Once the account provider has the inputted information associated with the session, the account provider can use the secret key to decrypt the inputted information and make a determination as to whether to provide access.

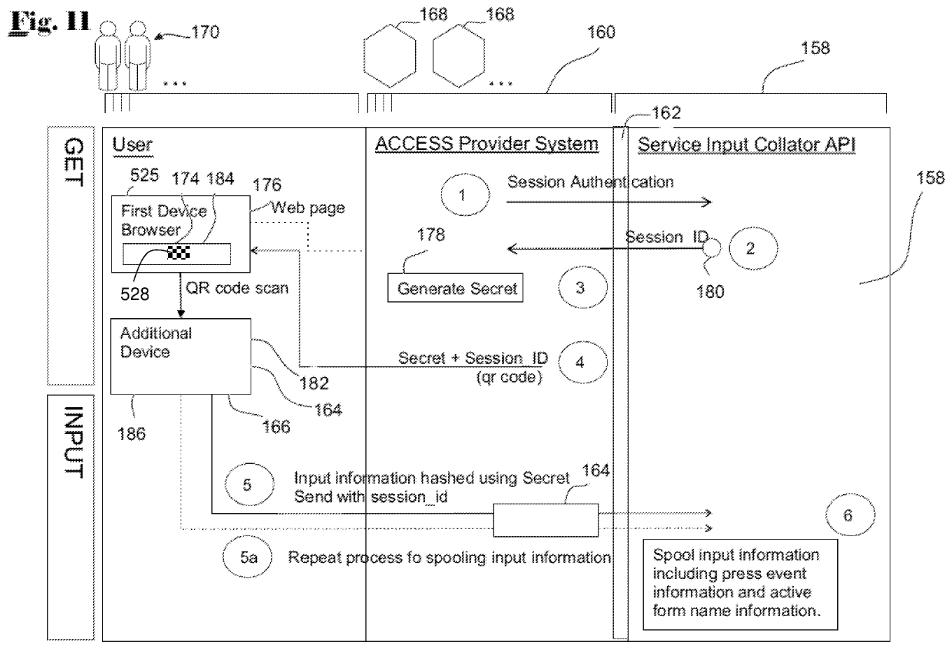

With reference to FIG. 11, by way of a technical description, in another embodiment there is provided a system service 158 that communicates with a number of access provider systems 160. The system service 158 provides an Application Programming Interface 162 that is accessible by TCP/IP. The API 162 receives and handles input information 164 in the form of keypress input information 166. It is of course possible that mouse, story-board and other input information could be provided in other embodiments.

The customers of the system service 158 comprise the access provider systems 160. The access provider systems 160 each provide a corresponding application 168 that provides access to a number of users 170. The applications 168 each comprise a web application 168 that serves Hypertext Markup Language that can be interpreted and displayed using a HTML Browser.

From the point of view of the system service 158 each access provider 160 comprises a customer 160 of the system service 158 and provides a web application 168 for access by users 170.

From the point of view of the users 170 of each access provider system 160, the web applications 168 provide secure content as webpages 174 viewable by each user 170, if the user is authorized by the corresponding access provider. A user 170 will use a web browser 176 to query a web application 168 that will generate a web page on the user's web browser 176. In the case of a financial provider the content could also comprise a CSV, PDF or another file format to which access is provided.

The web pages 174 are generated by the web applications 168 that are displayed on the end user's local web browsers 176 on first devices 525. The local web browsers 176 are able to be customized with extensions including automation and custom extensions according to each user's requirements.

A number of secrets 178 are generated by the web applications 168. Each secret 178 comprises a randomly generated string created by and known to the web application 168. The service 158 is secret-agnostic in the sense of being unware of the secrets generated by each access provider system 160.

Each secret 178 is associated with a corresponding session-id 180 of an access provider system's 160 web application 168. Each session-id 180 comprises a randomly generated session identifier known by the associated web application 168 as well as the system service 158. In this embodiment each session-id 180 is created by the system service 158 and is provided by the API 162 to the web application 168 of the corresponding access provider system 160. Various approaches could be utilised.

Each secret 178 is provided to each user 170 via a second device 182 for receiving and encrypting information inputted by the user. In this embodiment the encryption comprises a one-way hash function that is applied to an input made by the corresponding user 170.

Decryption of the user input information entered on the second device 182 by the web application 168 is possible by using hash tables and knowledge of the secret of the input session. In this embodiment the hash function comprises a message digest (‘one-way hash’) function, such as MD5 or SHA1.

As part of the GET phase, the session-id 180 and secret 178 are encoded in a web page 184. The session-id 180 and the secret 178 are presented to a user 170 as a visual representation in the web browser 176 of the user's first device 525, in response to a request made by the user 170 through the web browser 176. The session-id 180 and the secret 178 are presented in the form of a QR Code on the first device 525. Other visual representations are of course possible.

Each user's 170 second device 182 comprises a mobile device having an inbuilt camera for use in scanning the visual representation 528 providing the session-id 180 and the secret 178. The inbuilt camera is used by a mobile application 186 installed on each second device 182 that communicates user input along with the associated session-id 180 to the system service 158.

Each visual representation is presented to a user 170 in response to a web browser request, the visual representation being in the form of a QR code. The QR code that is generated by the associated web application 168 is scanned by the users 170 mobile application 186.

The method of operation includes session identifier creation. The session identifier creation includes the provision of a corresponding session identifier 180 by the system service 158 to a web application 168. Various approaches to the creation of session identifiers are possible provided that the web application can use the session identifier 180 to obtain keypress information from the system service 158 that is communicated by each second device 182 associated with a corresponding session-id 180. Various approaches for session-id creation would be apparent including creation by each webapp 168 and transmission to the system service 158 in association with a provider identifier.

In this embodiment, the session creation comprises a user making a request to a web application 168. The web application 168 then makes a request through the API 162 which generates and returns a unique session-id 180.

The web application 168 generates a random string as a secret 178 that is associated with the session-id 180. The generation of the session-id 180 and the secret 178 is performed for the purpose of providing the session-id 180 and secret 178 to the first device 525 of the particular user 170. The approach to this point can be considered as the ‘GET PHASE’ of the procedure.

In terms of the browser state integration, the end user's 170 web browser 176 displays a webpage 174 generated by the web application 168. The web page 174 contains the QR code to be scanned by the mobile application 186.

The QR code generation occurs with the web application creating the QR code 528 embedding the content of the session-id 180 and the associated secret 178. The mobile application 186 scans QR code 528 to receive the session-id 180 and the associated secret 178.

The mobile application 186 performs its own session authentication with the system service 158. Various authentication approaches are possible.

In this embodiment second device session authentication occurs with SC (the system service-generated challenge) being randomly generated by the system service 158 and sent to the mobile application 186. A CC (the client-generated challenge) is randomly generated by the mobile application 186. A CR (the client response) is computed by the mobile application 186 as HASH(CC+SC+SESSION-ID). The mobile application sends CC, CR and SESSION ID to the API. Various approaches are of course possible.

The system service 158 calculates the expected value of CR and verifies that the mobile application 130 responded correctly. This is the preferred approach after scanning the QR CODE to send the Session-id along with CC and CR.

A SR (server response) is computed by the system service 158 as HASH(SC+CC+SESSION-ID) and is sent to the mobile application 186. The mobile application 186 calculates the expected value of SR and verifies that the system service 158 responded correctly. The values of SC and CC are stored by the system service 158.

The GET Phase of the procedure is followed by the Input Phase. The Input Phase comprises encoding key presses on the mobile applications installed on the second devices. Once authentication between the mobile application 186 (the client) and the system service 158 has succeeded, the client-server session shares a SC and CC value that are unique to that connection.

Various encoding methods are able to be utilised. In the present embodiment a keycode value could be provided as a unique index of the key pressed on a virtual keyboard provided by the mobile application 186. A Unicode value could be provided as the Unicode value mapped from the keycode value.

As part of the keypress encoding, on the mobile application 186 a loop could run as follows:

### UnicodeKey:=GetLastKeyPressed( )

### EncryptedKey:=HASH(HASH(SC+CC+UnicodeKey)+SECRET)

### SecureChannelSend(EncryptedKey, API)

As noted above, the system service 158 does not know the secret 178. This is considered advantageous as the system service 158 operates in a status of user data anonymity. The web applications are the powerhouse of the decoding. To decode the keypresses a hash table is generated with all the possible encoded keypress values. The generated hash table is then used as a lookup table to retrieve the original values. In this manner decryption of the hashed key values occurs.

Importantly the session-id is send with the encrypted HASH(HASH(SC+CC+UnicodeKey)+SECRET). The system service spools the HASH(HASH(SC+CC+UnicodeKey)+SECRET) in an associated channel, the associated channel being associated with the session-id.

As part of the keypress encoding, the system service 158 records an encoded key list in a queue associated with the session-id. Advantageously the user can use either the web application 168 or the mobile application 186 to make a submit request. On receipt of a submit request associated with a session-id 180, the system service 158 performs the following functions and returns the result to the web application 168.

```
PartialEncodedKeyTable:= EMPTYTABLE
For UnicodeKey in UnicodeKeySet:
  PartialEncodedKey := HASH(SC + CC + UnicodeKey)
  PartialEncodedKeyTable [ PartialEncodedKey ] := UnicodeKey
return PartialEncodedKeyTable, EncodedKeyList
```

The web application 168 (if it makes the submit request) initiates a transfer of the PartialEncodedKeyTable and EncodedKeyList for a session-id from the system service 158. If the mobile application 186 makes the submit request, then the system service 158 could initiate the request of the data. Various approaches of achieving a similar effect are of course possible including streaming individual keypresses to the access provider system.

More particularly, in the example below, the web application 168 makes a request for the ‘partial encoded key table and the encoded list for a session’ from the system service 158. The web application 168 then performs a hash with the secret to generate a lookup table for the session in the web application 168. The approach is further detailed below: PartialEncodedKeyTable,EncodedKeyList:=getPartialEncodedKeyListForSession(SESSION-ID)

```
EncodedKeyTable := EMPTYTABLE
For PartialEncodedKey in PartialEncodedKeyTable:
  EncodedKey := HASH(PartialEncodedKey + SECRET)
  EncodedKeyTable[ EncodedKey ] := PartialEncodedKeyTable[ PartialEncodedKey ]
DecodedString := EMTPYSTRING
For EncodedKey is EncodePressList:
      DecodedString := DecodedString + EncodedKey Table[ EncodedKey ]
return DecodedString
```

The above approach is a particularly preferred approach for the reason of anonymity. Another approach would be for the mobile application 186 to share the secret with the system service 158. If this is done, the following less preferred approach could be provided by the system service 158.

```
EncodedKeyTable := EMPTYTABLE
For UnicodeKey in UnicodeKeySet:
EncodedKey := HASH(HASH(SC + CC + UnicodeKey) + SECRET)
EncodedKeyTable[ EncodedKey ] := UnicodeKey
EncodedKeyList := getEncodedKeyListForSession(SESSION-ID)
    DecodedString := EMTPYSTRING
    For EncodedKey is EncodePressList:
      DecodedString := DecodedString + EncodedKey Table[ EncodedKey ]
return DecodedString
```

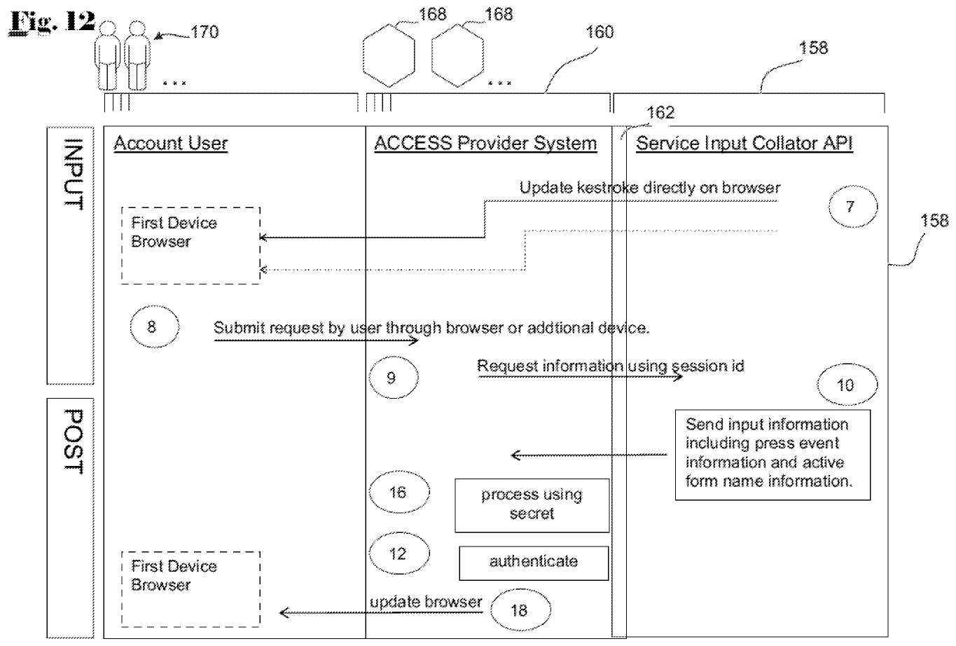

Referring to FIG. 13, in this embodiment each webpage 174 that is provided by a web application 168 for access authorisation further contains display elements 188 for showing information associated with input events made using the mobile application 186. More particularly, in the embodiment there is provided a selectable name element 190 and a selectable password element 192. Moreover, the webpage 174 advantageously provides a bi-directional web socket 194 that is able to send selection changes of the display elements 188 to the system service 158. Furthermore, the web socket 194 is able to receive input event information 196 from the system service 158. Another approach could be for the webpage to directly communicate with the associated second device. This is presently not preferred for the reason that the API interface provides a physical separation.

More particularly when a user inputs data into the mobile application 186, input event information is sent from the system service 158 to the webpage 174 as content-agnostic indicators. The content-agnostic indicators are content unware. When the end user clicks on or tab-keys between different HTML display elements 188, the WEBPAGE will send a ‘change active element’ event to the system service 158. The system service 158 will inform the associated second user device 182 which will account for the additional information by viewing the active element change as an input change. The system service 158 will record the ‘change active element’ as an input change in the collation.

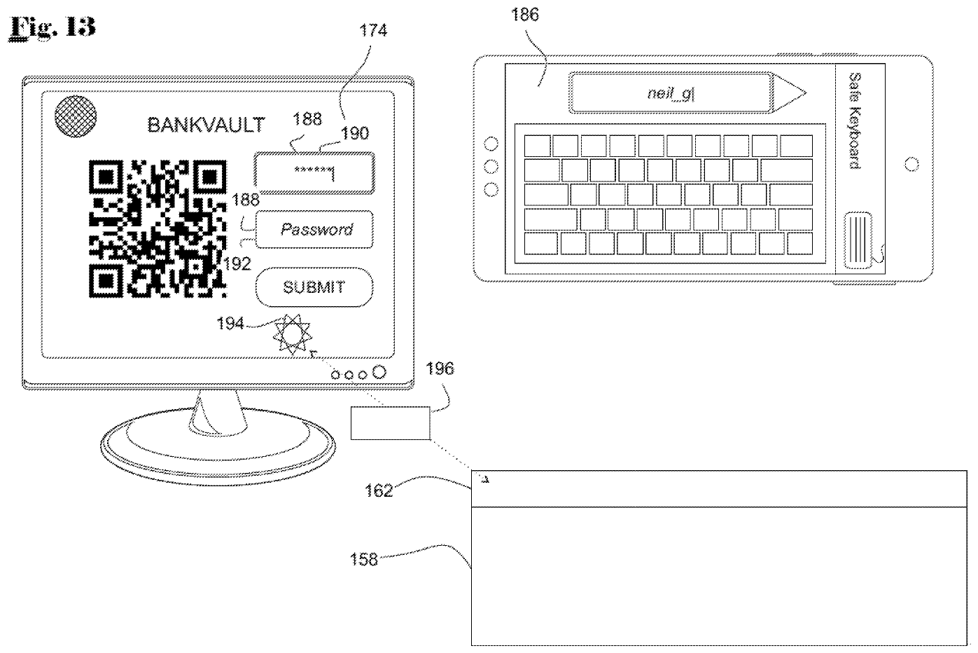

FIG. 14 shows inclusion of JavaScript in in the web browser for providing communication with the system service. In this embodiment, the JavaScript is hosted from the system service. Other approaches are of course possible.

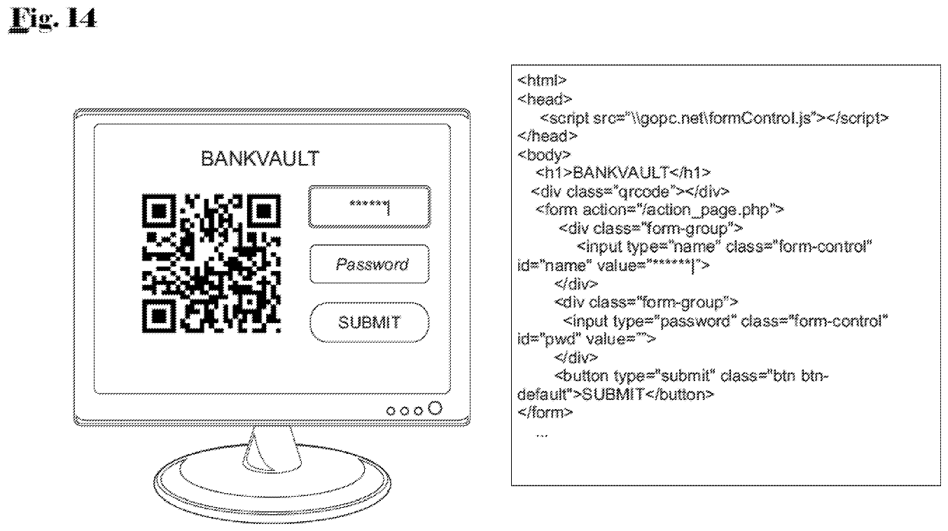

Referring to FIG. 15 there is show an example where the first device does not communicate directly with the system service. In such an embodiment the first device communicates via a websocket 195 to the application provider which the relays the information about display element changes on the first and second devices. It is to be appreciated that various approaches could be employed including the use proxies and which fall within the scope of the present application.

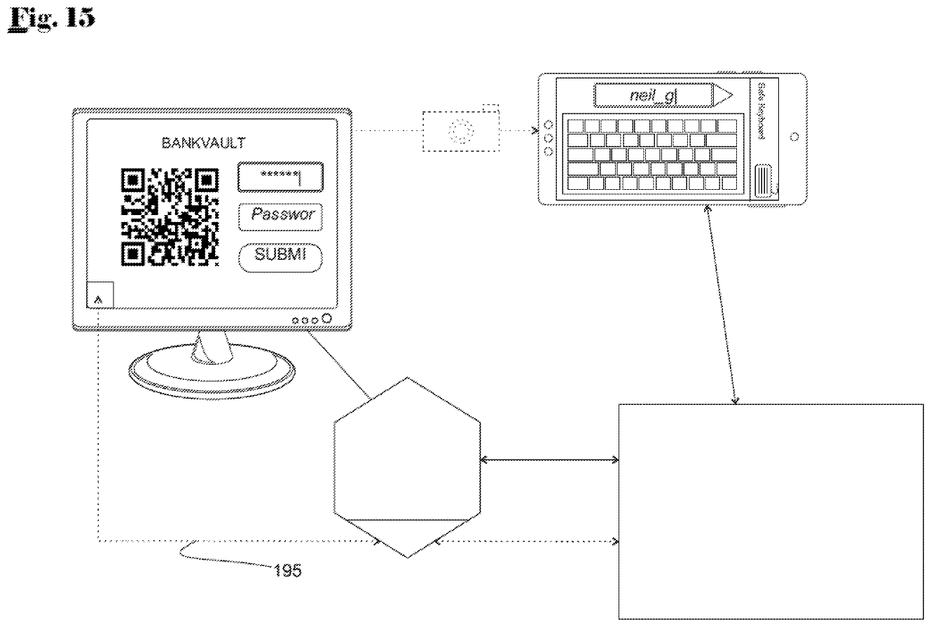

FIG. 16 provides an exemplary flow chat of an authorisation procedure according to an embodiment. A number of process steps are shown. These correspond to the numbered steps 1, 3, 4, 6, 7, 8 and 16 in circles in FIGS. 7 to 9.

It is to be appreciated that once the application provider has authorised the user, the user can be provided with access to a resource such as a virtual computer embedded in the webbrowser. Upon authorization, the virtual machine can be provisioned as described in related application PCT/AU2014/050050 filed 23 May 2014.

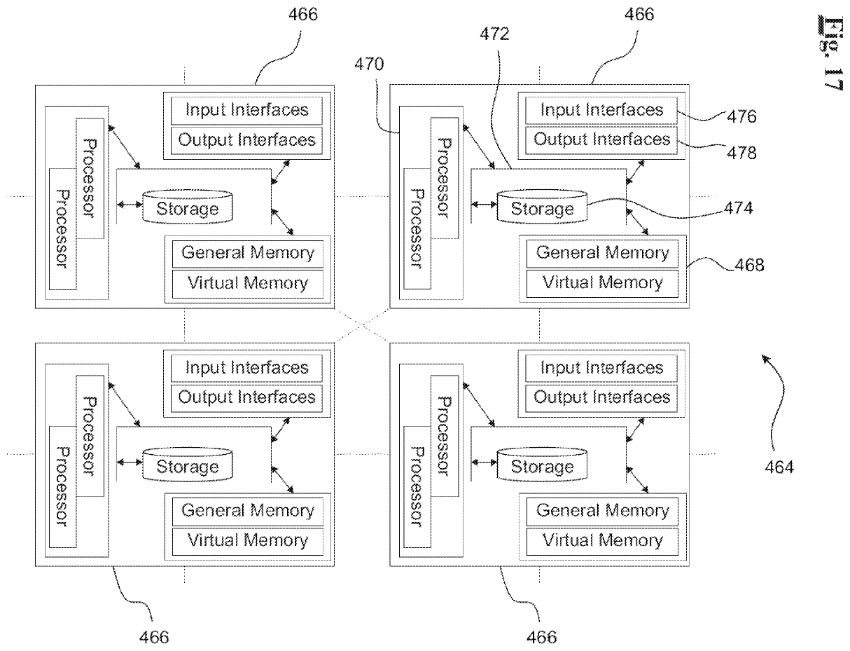

FIG. 18 shows an alternative embodiment, where two users (neil and fred), each having their own second device 186 and 189 and are providing entry to the one first device 14. Here, each scans the QR code displayed and both devices 186 and 189 can input into the corresponding active 190 display element 188. The backend process is the same as described above, however neither user of devices 186 198 can see what the other enters as only asterisks are displayed in the display element. Each can determine a character is entered, but not what the character is. This use can be advantageous when two (or more) parties need to independently contribute to the authorisation and neither is to be wholly trusted, such as in a “requires two signatures” scenario.

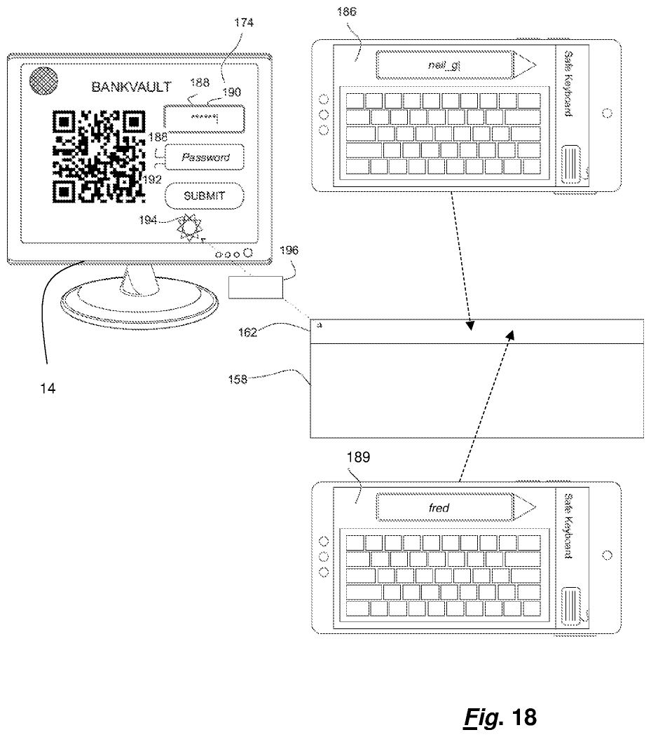

FIG. 19 provides another exemplary flow chart of an authorisation procedure according to an embodiment.

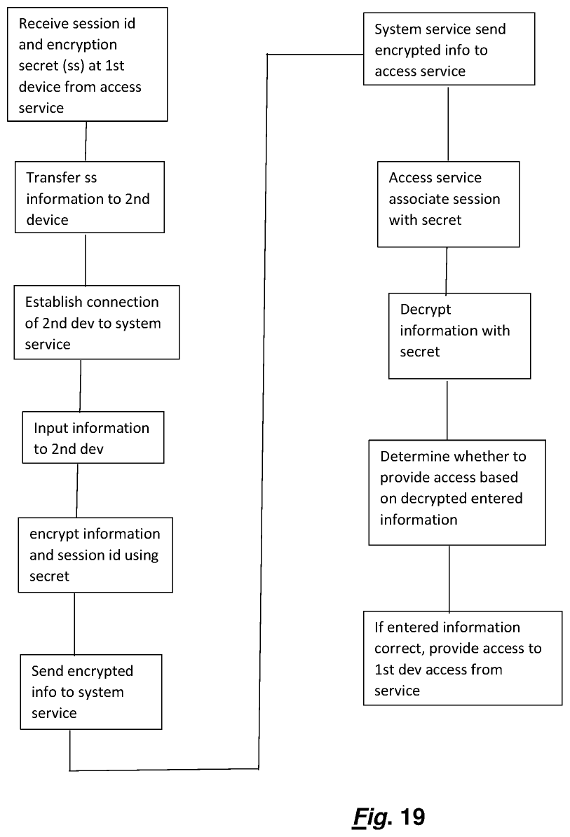

With reference to FIG. 20, in an embodiment the first device and the second device are the same physical device, such as when the user navigates to the access provider site using their smart phone and thus they cannot scan a QR code on their phone when using the phone. In an embodiment when a user navigates to a webpage provided by a webserver 122 of the access provider system 12, the webserver 122 determines whether the user is using a workstation or a mobile device. In an example, this is conducted by using the user-agent HTTP header. In the case that a mobile device is used the following variation is used.

In particular, in system 500, the functions of the first device and second device are performed by the same device, in this case a smart phone 26. When the smart phone 26 navigates to the website provided 506 by the webserver 122 in a window operating as the first device 14. The webserver 122 also provides another window, such as an Inline Frame (iFrame), which acts as the second device 26′ that provides a virtual keyboard 68. The keyboard 68 in the iFrame sends the input information 18 to the system 32 via an interface (API) 34. The API 34 then sends it to the access provider system 12 and the webserver 122 indicates an input has been made in the display element 144/148.

In one variation the display elements 144 and 146 are treated differently according to whether the information is secret. For example, display element 144 might be for receiving a user name, which for example might be an email address and is therefore not secret. Display element 146 might be for receiving a password, which is secret.

When display element 144 is selected to be active 142, it is entered using the phone's normal keyboard 502. What is entered (fred@email.com) is displayed in display element 144. When display element 146 is selected to be active (which is for receiving a secret, e.g. Password, PIN, Social Security Number, CVV#), the iFrame is called as if it is (a virtual instance of) the second device 26 and the keyboard 68 is displayed therein. The webserver 122 may also request a session identifier 180 for use as described above. In the Figure, the keyboard 68 is shown to be separate from keyboard 502. However, it is preferred that keyboard 502 be dismissed and keyboard 68 in the iFrame (of device 26) be in its place or it be overlaid. It is considered less desirable to have both keyboards be displayed at the same time. This iFrame is sandboxed from the parent webpage and communication can only be done via the known window.postMessage( ) browser mechanism.

The data input into keyboard 68 forms the input information 18 (in an embodiment with the session identifier 180) in encrypted form, which is sent to the system 32, via API 34, and then as input information 22 to the system 12. The entered information is then decrypted and verified by the system 12. The webserver 122 also transmits the content-agnostic information 72 for the device 14 to display in display element 146 the corresponding number of asterisks (as described in more detail above).

As mobile phone operating systems generally only allow one application to hold the screen at a time, when the browser is doing this, then nothing else should be able to intercept the image in the iFrame. Thus, there is an input device that can only be interpreted by the webserver 122, thus ensuring user data input should not be able to be intercepted by any malware on the device. Further, the only place that context (by use of the session identifier 180) exists to marry the non-secret (such as username entered through the normal workstation keyboard) and the secret (such as a password or other sensitive/confidential information entered through the Web Client Keyboard (keyboard 68) on a mobile), is inside the access provider system 12. When completed, the user can select the ‘submit’ element 148, indicating to the webserver 122 that the user has finished entering information, and the verification of their identify can be performed based on the entered information 18 entered via the keyboard 26. There may be an acknowledgement when there is a verification or a negative acknowledgement when there isn't.

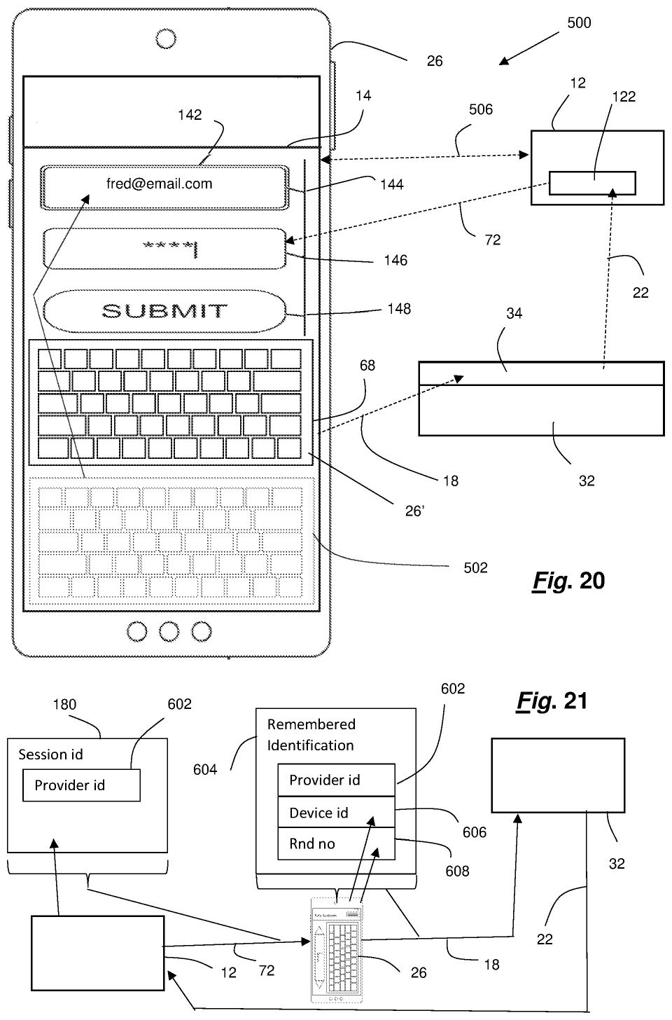

With reference to FIG. 21, in an embodiment each access system 12 has an identifier (provider ID 602). Further, the provider ID 602 can be provided from the access system 12 to the second device 26, via the system 34 in session information 180. In an embodiment the provider ID 602, information identifying and specific to the second device 26 (such as the mobile device type 606) and a non-readily-predictable number (such as a random number 608) are stored in local storage in the second device 26 as a remembered identifier 604 of the device 26 for the originating access provider system 12 (as, or similar to, a cookie) and included in the information 18.

In a different session, if the remembered identifier 604 is still present in the second device 26, it can again be sent in the information 18, or else another one is generated (in the same manner), stored in the second device 26 and sent in the information 18 (and then information 22 to system 12).

In an embodiment the access system 12 receives the remembered identifier 604 via information 22 send from the system 32. The remembered identifier 604 is able to be used by the access system 12 as a form of authentication that the second device 26 is the expected second device associated with the expected user, rather than an unexpected device/user, where if the remembered identifier 604 is retrieved (rather than newly created) is not what is expected to be used by the associated user, then this may be treated as suspicious, (potentially indicated a security breach, or fraud). Whereas if the respective user is using the expected device, as identified in the remembered identifier 604 provided via the system 32, then this can act as an additional form of authentication or for audit purposes.

In an embodiment the provider ID 602 is a unique ID identifying which access provider 12 has initiated this session with the user. Thus, there will be a different provider ID 602 (and thus a different cookie) for each access provider 12 that it connects to.

This can be beneficial when multiple devices are connected in parallel to the same access provider 12 providing multiple party authentication because each parties device adds a uniqueness to each users individual connection to the authentication session because of the unique identification 606 of the device (and also the random number 608) from which the information from the respective user is provided.

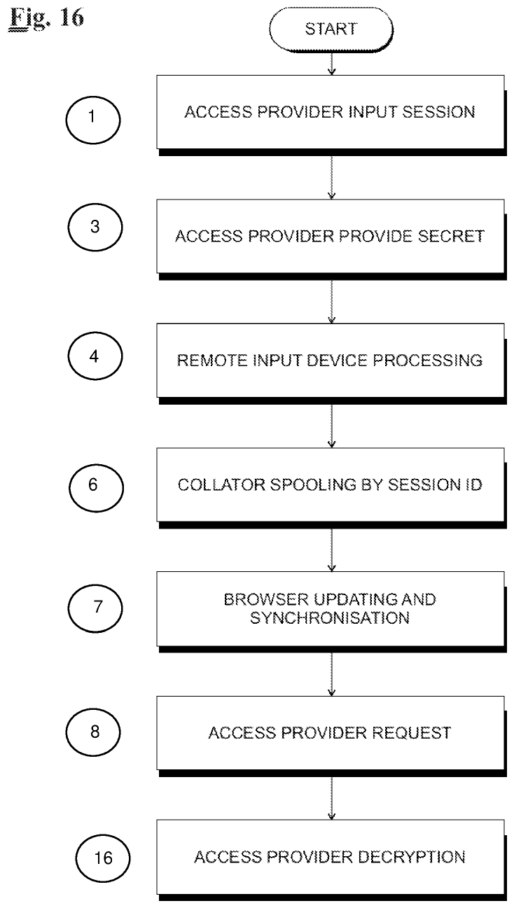

Referring to FIG. 17 there is shown a schematic diagram of a computer system 464 that is configured to provide preferred arrangements of systems and methods described herein. The computer system 464 is provided as a distributed computer environment containing a number of individual computer systems 466 (computers/computing devices) that cooperate to provide the preferred arrangements. In other embodiments the computer system 464 is provided as a single computing device.

As shown, a first one of the computing devices 466 includes a memory facility 468. The memory facility 468 includes both ‘general memory’ and other forms of memory such as virtual memory. The memory facility 468 is operatively connected to a processing facility 470 including at least one processor. The memory facility 468 includes computer information in the form of executable instructions and/or computer data. The memory facility 468 is accessible by the processing facility 470 in implementing the preferred arrangements.

As shown. each of the computing devices 466 includes a system bus facility 472, a data store facility 474, an input interface facility 476 and an output interface facility 478. The data store facility 474 includes computer information in form of executable instructions and/or computer data. The data store facility 474 is operatively connected to the processing facility 470. The data store facility 474 is operatively connected to the memory facility 468. The data store facility 474 is accessible by the processing facility 470 in implementing the preferred arrangements.

Computer information may be located across a number of devices and be provided in a number of forms. For example. the data store facility 474 may include computer information in the form of executable instructions and/or computer data. The computer data information may be provided in the form of encoded data instructions, data signals, data structures, program logic for server side operation, program logic for client side operation, stored webpages and so forth that are accessible by the processing facility 470.

On one level, input interfaces allow computer data to be received by the computing devices 466. On another level, input interfaces allow computer data to be received from individuals operating one or more computer devices. Output interfaces, on one level, allow for instructions to be sent to computing devices. On another level, output interfaces allow computer data to be sent to individuals. The input and output interface facilities 476, 478 provide input and output interfaces that are operatively associated with the processing facility 470. The input and output facilities 476, 478 allow for communication between the computing devices 466 and individuals.

The computing devices 466 provide a distributed system in which several devices are in communication over network and other interfaces to collectively provide the preferred arrangements. Preferably there is provided at least one client device in the system of computing devices 466 where the system is interconnected by a data network.

The client device may be provided with a client side software product for use in the system which, when used, provides systems and methods where the client device and other computer devices 466 communicate over a public data network. Preferably the software product contains computer information in the form of executable instructions and/or computer data for providing the preferred arrangements.

Input interfaces associated with keyboards, mice, trackballs, touchpad's, scanners, video cards, audio cards, network cards and the like are known. Output interfaces associated with monitors, printers, speakers, facsimiles, projectors and the like are known. Network interfaces in the form of wired or wireless interfaces for various forms of LANs, WANs and so forth are known. Storage facilities in the form of floppy disks, hard disks, disk cartridges, CD-ROMS, smart card, RAID systems are known. Volatile and non-volatile memory types including RAM, ROM, EEPROM and other data storage types are known. Various transmission facilities such as circuit board material, coaxial cable, fibre optics, wireless facilities and so forth are known.

It is to be appreciated that systems, components, facilities, interfaces and so forth can be provided in several forms. Systems, components, facilities, interfaces and so forth may be provided as hardware, software or a combination thereof. The present invention may be embodied as an electronics device, computer readable memory, a personal computer and distributed computing environments.

In addition the present invention may be embodied as: a number of computer executable operations; a number of computer executable components; a set of process operations; a set of systems, facilities or components; a computer readable medium having stored thereon computer executable instructions for performing computer implemented methods and/or providing computer implemented systems; and so forth. In the case of computer executable instructions, they preferably encode the systems, components and facilities described herein. For example, a computer-readable medium may be encoded with one or more facilities configured to run an application configured to carry out a number of operations forming at least part of the present arrangements. Computer readable mediums preferably participate in the provision of computer executable instructions to one or more processors of one or more computing devices.

Computer executable instructions are preferably executed by one or more computing devices to cause the one or more computing devices to operate as desired. Preferred data structures are preferably stored on a computer readable medium. The computer executable instructions may form part of an operating system of a computer device for performing at least part of the preferred arrangements. One or more computing devices may preferably implement the preferred arrangements.

The term computer is to be understood as including all forms of computing device including servers, personal computers, smart phones, digital assistants, electronics devices and distributed computing systems.

Computer readable mediums and so forth of the type envisaged are preferably intransient. Such computer readable mediums may be operatively associated with computer based transmission facilities for the transfer of computer data. Computer readable mediums may provide data signals. Computer readable mediums preferably include magnetic disks, optical disks and other electric/magnetic and physical storage mediums as may have or find application in the industry.

Components, systems and tasks may comprise a process involving the provision of executable instructions to perform a process or the execution of executable instructions within say a processor. Applications or other executable instructions may perform method operations in different orders to achieve similar results. It is to be appreciated that the blocks of systems and methods described may be embodied in any suitable arrangement and in any suited order of operation. Computing facilities, modules, interfaces and the like may be provided in distinct, separate, joined, nested or other forms and arrangements. Methods will be apparent from systems described herein and systems will be apparent from methods described herein.

As would be apparent, the method blocks herein described could be viewed in grouped blocks or subdivided blocks. Various flowcharts could be based on the blocks described.

Various embodiments are considered to be advantageous. A number of advantages are discussed in the second entitled Summary of the Invention. Other advantages would be apparent for a reading of the specification as a whole.

As would be apparent, various alterations and equivalent forms may be provided without departing from the spirit and scope of the present invention. This includes modifications within the scope of the appended claims along with all modifications, alternative constructions and equivalents.

There is no intention to limit the present invention to the specific embodiments shown in the drawings. The present invention is to be construed beneficially to the applicant and the invention given its full scope.

In the present specification, the presence of particular features does not preclude the existence of further features. The words ‘comprising’, ‘including’, ‘or’ and ‘having’ are to be construed in an inclusive rather than an exclusive sense.

It is to be recognised that any discussion in the present specification is intended to explain the context of the present invention. It is not to be taken as an admission that the material discussed formed part of the prior art base or relevant general knowledge in any particular country or region.

1. A computer implemented method of enabling an access provider system to secure access to content on a first electronic device, the computer implemented method comprising:
receiving encrypted input information, the encrypted input information being inputted by a user on a second electronic device; and
transmitting input information to the access provider system to allow the access provider system to determine whether to authorise access to the first electronic device.

2. A computer implemented method of enabling one or more access provider systems to secure access to content on first electronic devices, the computer implemented method comprising:
receiving encrypted input information, the encrypted input information being inputted by users on second electronic devices; and
transmitting input information to the one or more access provider systems to allow the one or more access provider systems to determine whether to authorise access to content on the first electronic devices.

3. A computer implemented method as claimed in claim 1, wherein the method includes providing a system service having an application interface, the application interface for receiving the encrypted input information and transmitting the received encrypted input information from the system service to the one or more access provider systems.

4. A computer implemented method as claimed in claim 3, wherein (i) each access provider system has access to decryption keys for decrypting the transmitted input information; and (ii) the system service does not have access to the decryption keys and is unable to decrypt the received encrypted input information.

5. A computer implemented method as claimed in claim 1 including generating session identifiers; each session identifier for identifying a user input session in association with a corresponding access provider system and a corresponding second electronic device.

6. A computer implemented method as claimed in claim 5 including each access provider system generating a secret key for each session identifier associated with the access provider system.

7. A computer implemented method as claimed in claim 6 including presenting each session identifier and the corresponding secret key as a visual representation on the first electronic devices for scanning by the second electronic devices.

8. A computer implemented method as claimed in claim 5 including using each secret key in the encryption of information that is inputted by the user for the purposes of obtaining access to content on the corresponding first device.

9. A computer implemented method as claimed in claim 5 including collating encrypted input information inputted by the users using the second electronic devices, based on the corresponding session identifiers; and providing collated input information associated with each session identifier to the one or more access provider systems based on the corresponding session identifiers.

10. A computer implemented method as claimed in claim 1, wherein the or each session identifier comprises an identifier of the respective access provider system and the method further comprises storing the respective access provider system identifier in the respective second device.

11. A computer implemented method as claimed in claim 10, further comprising storing the respective access provider system identifier and one or both of a device identifier or a non-predicable number as a remembered identifier in the respective second device.

12. A computer implemented method as claimed in claim 11, including transmitting the remembered identifier to the access provider system.

13. A computer implemented method as claimed in claim 12, wherein the respective access provider system compares the received remembered identifier to a previously received remembered identifier having the same second device identifier.

14. A computer implemented method as claimed in claim 1 wherein the method includes receiving requests from the one or more access provider systems to provide input session identifiers, each input session identifier being provided for use in providing secure access to content from an associated access provider system to a user.

15. A computer implemented method as claimed in claim 14 wherein the method includes providing a software application on each of the second electronic devices, the software application for providing an input system for use in authorizing a user to access content on a first electronic device.

16. A computer implemented method as claimed in claim 1 including transmitting content-agnostic and length-aware input information to corresponding first electronic devices after receiving input information from the second electronic devices.

17. A computer implemented method as claimed in claim 1 including transmitting content-agnostic and length-unaware input information to corresponding first electronic devices after receiving input information from the second electronic devices.

18. A computer implemented method as claimed in claim 1 including receiving display element selection information from the first devices as further input information from the users that is made directly on the first devices.

19. A computer implemented method as claimed in claim 18 including monitoring display element changes on each first user device made directly by the corresponding user.

20. A computer implemented method as claimed in claim 18 including informing corresponding second electronic devices of display element selection on the first electronic devices.

21. A computer implemented method of enabling an access provider system to secure access to content on an electronic device via a first communication channel between the access provider system and the electronic device, the computer implemented method comprising:
receiving encrypted input information via a second communication channel between a second device and the access provider system, the encrypted input information being inputted by a user; and
transmitting input information to the access provider system to allow the access provider system to determine whether to authorise access to the first electronic device.

22. A computer implemented method as claimed in claim 20, wherein the information is inputted by the user on the second device.

23. A computer implemented method as claimed in claim 1, further comprising implementing the or each second device in the form of an input device on the, or each corresponding, first device.

24. A computer implemented method as claimed in claim 23, wherein the inputted information is unable to be provided to the access provider system via the first communication channel.

25.-64. (canceled)
